(19) United States
(12) Patent Application Publication
(10) Pub. No.: US 2006/0136713 A1
(43) Pub. Date: Jun. 22, 2006

(54) System and method for providing fault tolerant security among a cluster of servers

(76) Inventors: Vincent J. Zimmer, Federal Way, WA (US); Michael A. Rothman, Puyallup, WA (US); Robert C. Swanson, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,273

(22) Filed: Dec. 22, 2004

(51) Int. Cl. H04L 9/00

(52) U.S. Cl. 713/150

(57) ABSTRACT

A system and method are described for performing security operations for a cluster of servers. In one embodiment, a global secret is generated which is used to perform security operations for the cluster of servers. A plurality, n, shadows are generated based on the global secret. A subset of the plurality of shadows, m, may be used to recreate the global secret. The plurality of shadows are then distributed and stored across the plurality of servers.

### BACKGROUND

1. Field of the Invention

This invention relates generally to the field of data processing systems. More particularly, the invention relates to a system and method for providing fault tolerant security functions within a clustered server environment.

2. Description of the Related Art

Clusters of servers may be configured to work together to perform complex tasks. One particular type of clustered server is known as a “blade” server. A blade server is a thin module or electronic circuit board which is designed to be mounted in a blade server chassis with a number of other blade servers.

Blade server configurations are particularly efficient because each of the blade servers share centralized resources within the chassis such as fans, power supplies, Ethernet switching, and server management hardware. With respect to server management, a unified management module (“UMM”) is configured to perform central management functions for the entire cluster of blade servers. One particular function handled by the UMM is security. For example, the UMM typically maintains a shared secret or private key to enable encryption/decryption and authentication services for the entire server cluster.

One problem which exists with this arrangement is that because the global secret is managed from a single location, i.e., the UMM, the global secret is more vulnerable to cryptographic attacks. In addition, the UMM represents a single point of failure for the entire blade server chassis. Accordingly, a more secure and fault tolerant mechanism for managing security within the cluster of servers is desirable.

### BRIEF DESCRIPTION OF THE DRAWINGS

A better understanding of the present invention can be obtained from the following detailed description in conjunction with the following drawings, in which:

FIG. 1 illustrates a blade server chassis according to one embodiment of the invention.

FIG. 2 illustrates an architecture for implementing threshold cryptography according to one embodiment of the invention.

FIG. 3 illustrates a process for implementing threshold cryptography according to one embodiment of the invention.

FIG. 4 illustrates a process for implementing ElGamal cryptography according to one embodiment of the invention.

FIG. 5 illustrates an application within which an embodiment of the invention is implemented.

### DETAILED DESCRIPTION OF PREFERRED EMBODIMENTS

Described below is a system and method for managing session data within a multi-tiered enterprise network. Throughout the description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

### An Exemplary Cluster Architecture

The embodiments of the invention described herein may be implemented within a blade server architecture. Accordingly, a brief overview of the blade server architecture will initially be provided. It should be noted, however, that the underlying principles of the invention are not limited to a blade server architecture. For example, the embodiments of the invention may be implemented within any clustered server environment, including a standard rack-mounted cluster.

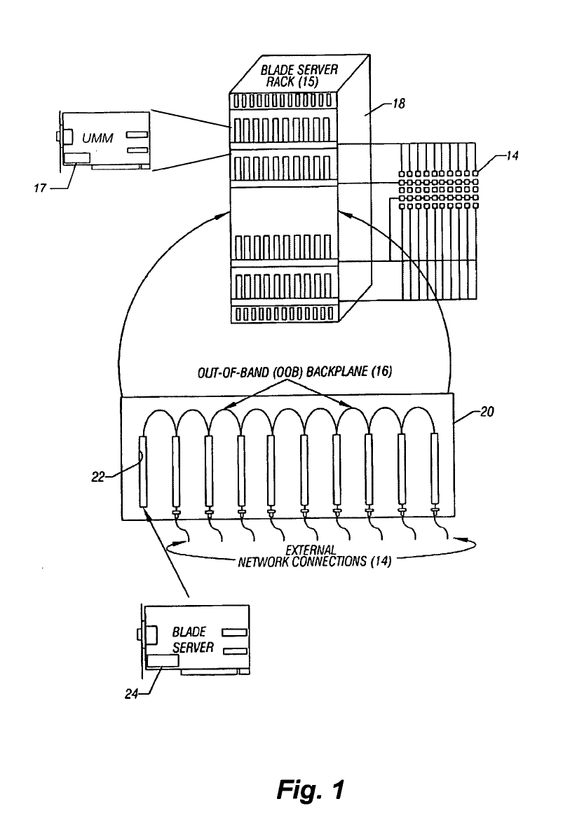

A blade server architecture according to one embodiment of the invention is illustrated generally in FIG. 1. A cluster of blade servers 24 are shown mounted in a rack 15 including a housing 18. A plurality of layers 20 are configured within the rack 15. Each layer 20 includes a set of openings 22 to receive the blade servers 24 (e.g., in a slide-fit connection). Each of the servers 24 in a layer 20 communicate through an out-of-band (“OOB”) back plane 16. The servers 24 communicate with external servers and/or clients (or other types of data processing devices) via connections 14 to an external network. In one embodiment, the connections 14 are Ethernet connections. However, the underlying principles of the invention are not limited to any particular network interface. The external network may include the Internet, a local area network, or any other type of network. Thus, in some embodiments, the rack 15 of blade servers 24 may be coupled to the Internet to perform the functions of a Web server. In other embodiments, the blade server rack 15 may be part of a large data center.

A unified management module (“UMM”) 17 is integrated within the blade server rack 15 to perform central management functions for the entire cluster. These management functions include, for example, deployment services for new blade servers, thermal monitoring and blower speed regulation, diagnostics, and various security management functions (e.g., such as those described herein). Additional information related to the UMM and the blade server architecture may currently be found at http://www.intel.com/design/servers/blades.

### Embodiments of a System and Method for Fault Tolerant Security

Unlike prior systems in which a global secret (e.g., a private key) is managed from a central location, one embodiment of the invention distributes fragments of the global secret among the plurality of blade servers. Specifically, one embodiment employs a threshold cryptography scheme in which the global secret is divided into n pieces, referred to as “shadows.” Any m of the n shadows may be used to reconstruct the global secret (referred to as an “(m, n)-threshold scheme”). Thus, if the n shadows are distributed across n blade servers, the global secret may still be reconstructed if one or more of the n blade servers crash (i.e., as long as m of the n shadows can be recovered). In this manner, network authentication of the rack may be performed without revealing the global secret to any one of the associated blade servers.

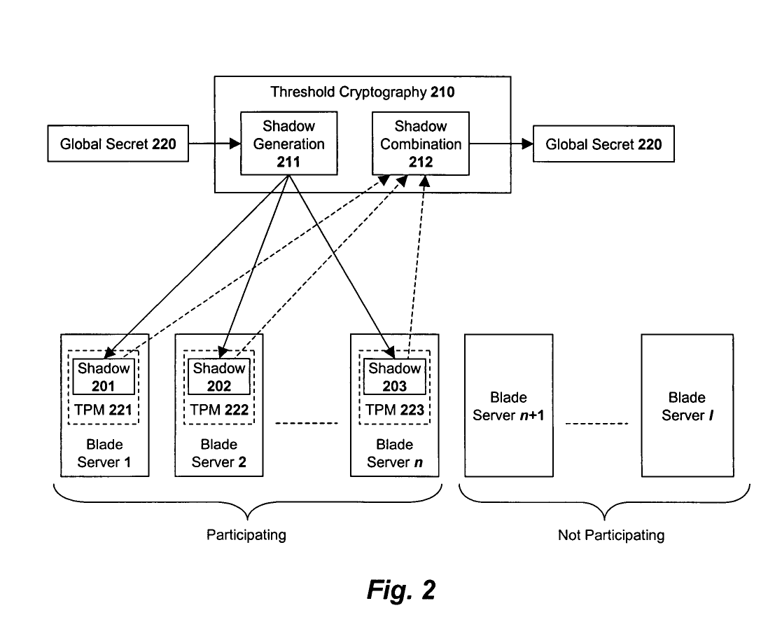

FIG. 2 illustrates a threshold cryptography module 210 according to one embodiment of the invention which includes shadow generation logic 211 for dividing a global secret 220 into a plurality of shadows 210-203 and shadow combination logic 212 for combining the shadows to recreate the global secret. In one embodiment, the threshold cryptography module 210 is implemented within the UMM of the blade server rack. However, as previously mentioned, the underlying principles of the invention are not limited to a blade server implementation.

In one embodiment, the shadow generation logic 211 distributes the shadows 201-203 among a designated subset of blade servers 1, 2, . . . n, using the out-of-band (“OOB”) communication channel. In one embodiment, the shadows are securely stored on each of the blade servers using trusted platform modules (“TPMs”) 221-223. TPMs are special-purpose integrated circuits (“ICs”) which enable strong user authentication and machine attestation, thereby preventing unauthorized access to confidential data. The TPM “seal” command is used to store the shadow data within the TPMs 221-223. In one embodiment, the TPMs 221-223 are coprocessors configured within each of the blade servers. Additional details associated with the TPM architecture can be found at https://www.trustedcomputinggroup.org.

The shadow combination logic 212 reads the shadows 201-203 from each of the participating blade servers over the OOB channel to regenerate the global secret 220. As mentioned above, for an (m, n)-threshold scheme, the shadow combination logic 212 is capable of generating the global secret 220 as long m of the n shadows are available. Thus, the global secret 220 may still be generated even if one or more of the participating blade servers goes down, resulting in improved redundancy.

Various different schemes for storing the shadows may be implemented while still complying with the underlying principles of the invention. For example, in one embodiment, multiple shadows are stored on each participating blade server. For example, a different shadow may be stored for each potential combination of blade servers used to generate the global secret (as described in greater detail below).

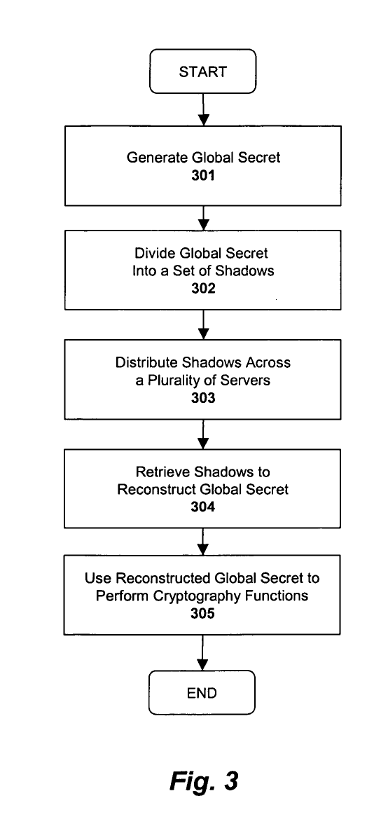

A process for implementing security functions for a plurality of servers according to one embodiment of the invention is illustrated in FIG. 3. At 301, a global secret such as a private key is generated. At 302, the private key is divided into a set of shadows. The number of shadows depends on the particular threshold cryptography scheme being implemented (e.g., n shadows for an (m, n)-threshold scheme). At 303, the shadows are distributed across a plurality of servers in the cluster. For example, when implemented in a blade server rack, each blade server within the group of participating blade servers stores one or more of the shadows (e.g., via a TPM module as described above). At 304, the shadows are read from each one of the group of servers and are used to reconstruct the global secret. Finally, at 305, the reconstructed global secret is used to perform cryptography functions (e.g., encryption/decryption, authentication, etc).

In one embodiment of the invention, threshold cryptography techniques are used in conjunction with the ElGamal cryptosystem. ElGamal encryption is defined by the following equations:
E_{(g,y,p)}(M)=(C₁, C₂)=[g^{k}(mod p), My^{k}(mod p)];
y=g^{x}modp
where M represents the message to be encrypted, p is a prime number, k is random and is relatively prime to p-1, x is a randomly-generated private key, and y is the public key. In one embodiment, the ElGamal encryption is implemented as part of the Transport Layer Security (“TLS”) handshake protocol, defined in the Request for Comments RFC2246 (see, e.g., http://www.faqs.org/rfcs/rfc2246.html).

ElGamal decryption of the message M is defined by the following series of equations:

$$\begin{matrix}{D}_{( a , p )} ( {C}_{1} , {C}_{2} ) = {C}_{2} {C}_{1}^{- a} ( mod p ) \\ = {{My}^{k} ( {g}^{k} )}^{- a} ( mod p ) \\ = {M ( {g}^{a} )}^{k} {( {g}^{k} )}^{- a} ( mod p ) \\ = {Mg}^{ak} {g}^{- ak} ( mod p ) \\ = M ( mod p )\end{matrix}$$

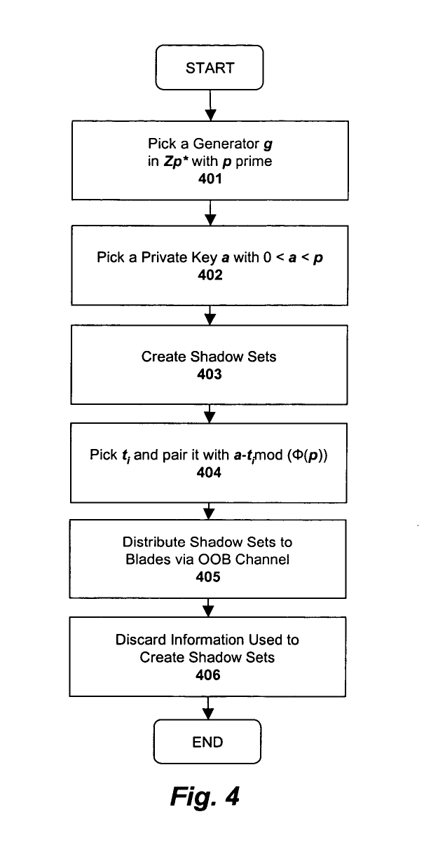

One embodiment of a process for implementing the ElGamal cryptosystem with threshold cryptography for a group of blade servers is illustrated in FIG. 4. For the purpose of illustration, a (2/I) threshold cryptosystem is described. However, the underlying principles of the invention are not limited to any particular threshold cryptography scheme.

At 401, a generator g is selected in Zp* with p prime. That is, the generator g is selected which is relatively prime to p. At 402, a private key a is selected (e.g., randomly generated) with 0<a<p. At 403, the values selected in steps 401 and 402 are used to create several shadow sets, one per each potential pair of blades. Because the example deals with a (2, n) threshold cryptosystem, shadows from any two blade servers may be used to regenerate the secret. Moreover, a separate shadow is stored on each blade server for each possible combination with shadows from other blade servers (i.e., the shadows are different depending on the pairings between blade servers). For example, for the pairing (blade 1<->blade 2), the shadow retrieved from blade 1 is different than the shadow retrieved for the pairing (blade 1<->blade 3). The end result is that for a set of n participating servers, each blade server is provided with n-1 shadows (i.e., with each shadow corresponding to one of the other participating blade servers).

As indicated at 404, in one embodiment, the shadow pairs are represented by tᵢ and a-tᵢ mod ((Φ(p)) where “i” designates an index to the related blade server. The variables tᵢ and a-tᵢ mod ((Φ(p)) are two fragments that have a discrete log relationship. Thus, knowing tᵢ doesn't necessarily divulge f(tᵢ) (e.g., that other function with mod's and Φ). As a result, the compromise of ti does not result in the compromise of the related shadow.

At 405, the shadow pairs are distributed to the blades via the OOB channel by storing one of the numbers from each pair to one blade server and the other number from the pair to a different blade server. Thus, as mentioned above, each blade should have n-1 shadows, one for each other potential interaction that exists (e.g. blade 1<->blade 2, blade 1<->blade 3, etc).

Finally, at 406, after the shadows are created, the distributor of the shadows (e.g., the threshold cryptography module 210 from FIG. 2) destroys all information related to the shadow generation (e.g., the shadow pairs) so that no individual server has the actual secret key or a way to reconstruct it without n-1 other conspirators.

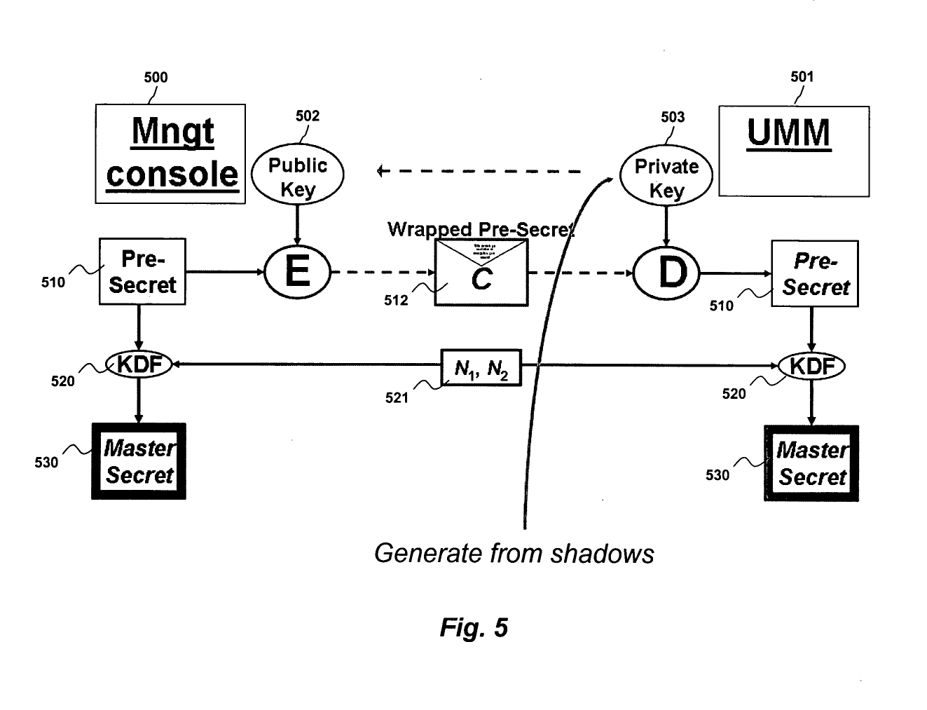

As indicated in FIG. 5, in one embodiment, the threshold cryptography techniques described herein are used to create the UMM's private key for use in the key encapsulation phase of TLS/Secure Sockets Layer (“SSL”) protocol. Specifically, a pre-secret 510 is encrypted using a public key 502 at a management console (e.g., a client computer) to create an encrypted pre-secret 512. At the receiving end, the UMM 501 within the blade server rack creates its private key 503 by combining a subset of the n shadows stored on the various blade servers (e.g., as described above). It then uses the private key 503 to decrypt the pre-secret 512.

As illustrated, a key derivation function (“KDF”) may be applied to the pre-secret 510 at either end to generate a master secret 530. A KDF is a cryptographic hash function which is designed to make a key or password harder to attack using a precomputed dictionary attack or brute force attack. It is normally expressed as DK=KDF(Key, Salt, Iterations) where DK is the derived key, KDF is the key derivation function, Key is the original key or password, Salt is a random number which acts as cryptographic salt, and Iterations refer to the number of iterations of a sub-function. The derived key is used instead of the original key or password as the key to the system. The values of the salt and the number of iterations (if it isn't fixed) are stored with the hashed password or sent as plaintext with an encrypted message. In this example, the N1 and N2 parameters 521 represent the salt and iterations applied to the KDF.

Embodiments of the invention may include various steps as set forth above. The steps may be embodied in machine-executable instructions which cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. For example, although many of the embodiments set forth above employ ElGamal encryption/decryption, the underlying principles of the invention are not limited to any particular cryptographic algorithm. Moreover, although some of the embodiments set forth above are implemented within a blade server environment, the underlying principles of the invention are equally applicable to other clustered server environments. Moreover, the techniques described above may be employed as part of a variety of different network authentication protocols which require a global secret (e.g., layer 2 Extensible Authentication protocol (“EAP”)/802.1x, layer 3 Secure Sockets Layer (“SSL”)/Transport Layer Security (“TLS”), etc).

Accordingly, the scope and spirit of the invention should be judged in terms of the claims which follow.

What is claimed is:

1. A method comprising:
generating a global secret usable to perform security operations for a cluster of servers;
generating n shadows based on the global secret wherein m of the n shadows may be used to recreate the global secret; and
distributing and storing the n shadows across the plurality of servers.

2. The method as in claim 1 further comprising:
reading m of the n shadows from each of the plurality of servers; and
reconstructing the global secret using the m shadows.

3. The method as in claim 2 wherein the global secret is a private key, the method further comprising:
encrypting and/or decrypting a data stream using the private key.

4. The method as in claim 2 further comprising:
performing an authentication operation using the private key.

5. The method as in claim 1 wherein m=n.

6. The method as in claim 1 wherein distributing the n shadows across the plurality of servers comprises:
storing a different shadow on each of the plurality of servers.

7. The method as in claim 6 wherein storing further comprises:
storing each shadow within a trusted platform module on each of the plurality of servers.

8. The method as in claim 1 wherein the global secret is generated according to the ElGamal cryptosystem.

9. A system comprising:
a cluster of servers to perform data processing and data storage operations, the cluster of servers communicatively coupled over a data communications medium;
a threshold cryptography module including shadow generation logic to generate n shadows based on a global secret, the global secret usable to perform security operations for the cluster of servers, wherein m of the n shadows may be used to recreate the global secret, the threshold cryptography module to distribute the n shadows across the plurality of servers.

10. The system as in claim 9 wherein the threshold cryptography module includes shadow combination logic to read m of the n shadows from each of the plurality of servers; and reconstruct the global secret using the m shadows.

11. The system as in claim 10 wherein the cluster of servers comprise a cluster of blade servers within a blade server chassis.

12. The system as in claim 11 further comprising a unified management module on which the threshold cryptography is implemented.

13. A machine-readable medium having program code stored thereon which, when executed by a machine, causes the machine to perform the operations of:
generating a global secret usable to perform security operations for a cluster of servers;
generating n shadows based on the global secret wherein m of the n shadows may be used to recreate the global secret; and
distributing and storing the n shadows across the plurality of servers.

14. The machine-readable medium as in claim 1 comprising additional program to cause the machine to perform the operation of:
reading m of the n shadows from each of the plurality of servers; and
reconstructing the global secret using the m shadows.

15. The machine-readable medium as in claim 2 wherein the global secret is a private key, the machine-readable medium comprising additional program to cause the machine to perform the operation of:
encrypting and/or decrypting a data stream using the private key.

16. The machine-readable medium as in claim 2 comprising additional program to cause the machine to perform the operation of:
performing an authentication operation using the private key.

17. The machine-readable medium as in claim 1 wherein m=n.

18. The machine-readable medium as in claim 1 wherein distributing the n shadows across the plurality of servers comprises:
storing a different shadow on each of the plurality of servers.

19. The machine-readable medium as in claim 6 wherein storing further comprises:
storing each shadow within a trusted platform module on each of the plurality of servers.

20. The machine-readable medium as in claim 1 wherein the global secret is generated according to the ElGamal cryptosystem.
